(19) United States
(12) Patent Application Publication
(10) Pub. No.: US 2011/0143325 A1
(43) Pub. Date: Jun. 16, 2011

(54) Automatic Integrity Checking of Quran Script

(75) Inventors: Awad Husain Al-Khalaf, Sharjah (AE); Anas Lutfi Nayfeh, Sharjah (AE)

(73) Assignees: Awad Al-Khalaf, Sharjah (AE); Anas Lutfi Nayfeh, Sharjah (AE)

(21) Appl. No.: 12/637,992

(22) Filed: Dec. 15, 2009

(51) Int. Cl. G09B 19/00

(52) U.S. Cl. 434/245

(57) ABSTRACT

An independent automated mechanism is invented that is able to:
a. Revise the Holy Quran book (in Hafs and Warsh versions) after scanning it and then saving it in Computer's storage devices.
b. Revise a set of Holy Quran verses (in Hafs and Warsh versions) written in the Internet.
c. Revise the Holy Quran verses that are saved in mobile and handheld devices.

In one variety, this mechanism is embedded into a website, allowing the Internet user to check the integrity of the Quran Verses mentioned in any selected third-party website. This can be accomplished by entering the selected third-party website address or by entering the verses themselves.

In another variety the mechanism is attached to a scanner with an automated page-turner that can electronically turn pages. The Holy Quran can be scanned and revised without the need of human hands to turn the pages.

### BRIEF DESCRIPTION OF THE VIEW OF THE DRAWING

The invention will be now described by way of illustration with reference to the accompanying drawing.

FIG. 1:

Shows the linkages used between the various tables.

FIG. 2:

Shows splitting of the table/file into multiple tables/files, each corresponding to one chapter of the Holy Quran book.

### DETAILED DESCRIPTION OF THE INVENTION

The invention is based on a hashing mechanism. The Holy Quran book has 114 chapters, with each chapter having a number of verses (1 . . . n). Each verse contains (1 . . . m) words that are made up of letters, vowel diacritics and other symbols (i.e. Fatha, Kasra . . . etc).

The first stage of the invention is about generating a hash table (i.e. a data structure) that maps each key to values accordingly. This allows an efficient lookup for a key (input verse) associated with a certain value (output verse) using the hash function. Only letters are mapped at this stage (vowel diacritics and symbols will not be used at this stage). The reason for this is again based on efficiency.

The used data structure for the hashing table is as follows:

1, <verse_id>
2,<verse_id>
3,<verse_id>
...
...
4323, <verse_id>

A verse_id would point to the raw table that contains the corresponding full verse of the Holy Quran, which in turn can be associated with a linked list of size one-to-many. A special data structure was formatted and devised for this linked list, and it is as follow:
<verse_id>, <chapter number>, <verse number>, <data>

Several tables are constructed to achieve this. First, a table is constructed to map words with their containing verses. This table contains two attributes; the first stores the hash code (index) of a word, while the other stores the verse_id of the verse that contains that specific word.

Another table is constructed that stores the actual content of the verses. Each record in this table has a unique id called data_id.

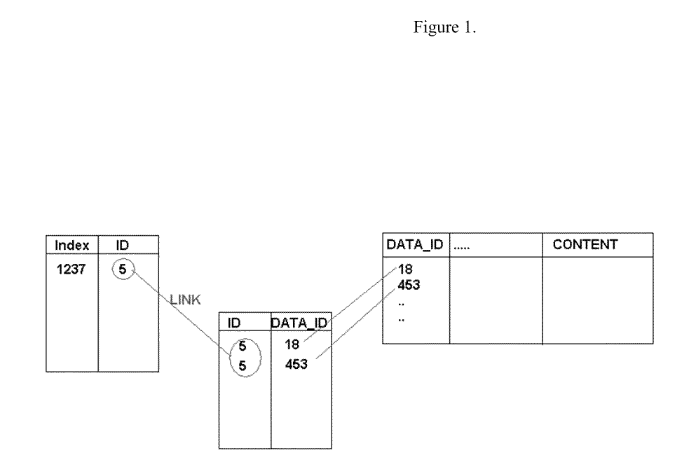

A final table, the link table, is constructed to map each verse_id to the corresponding data_id. This table is used as an intermediate fetching stage connecting the first and the second tables (FIG. 1).

In FIG. 1, we see that the input text entered returned a value of 1237 using our hashing functions. This value corresponds to verse_id 5. This verse_id is then used to reference the link table, which tells us that there are 2 verses found. The data_id's of those two verses is used to lookup the contents (data file) that contains the actual verse. That would be our target result output.

The second stage of the invention is to devise a logic and heuristics in order to deal with symbols positions and matching the relevance of each combination. This requires a setup of additional lookup tables, which would hold the data for the symbols, along with their order for each of the words belonging to a particular verse.

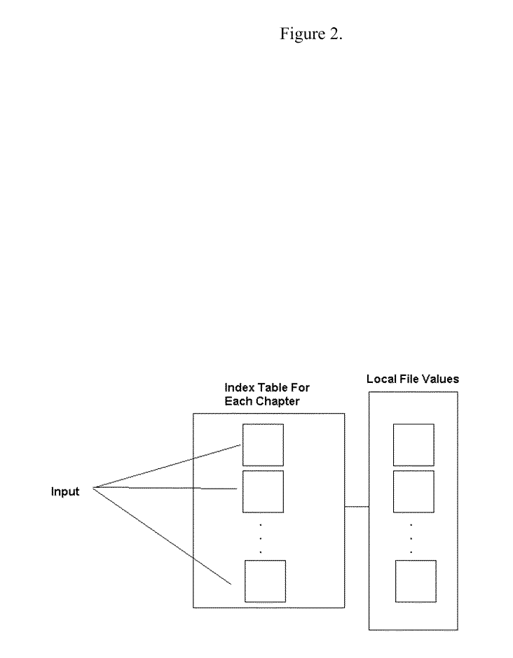

Having one single file for the hash table is not ideal in this case. This is due to the fact that the file size can grow very large, as it has to cope with many combinations and orders. Larger file sizes can slow down the search. Therefore, a hash table is generated for each chapter of the Holy Qur'an (114 in total) as in FIG. 2.

The next step was constructing a structured index file that contains information of vowel diacritics and other symbols. Once a match is found, this file will be analyzed to check the positions and validity of each symbol for that verse. Special rules/heuristics must be introduced to cope with different cases in addition to this process.

If a match cannot be found, the input text needs to be adjusted intelligently and then re-processed until it is exhausted. For example, consider the case where the input text has 3 words. The first two words were valid but the third was not. Since the last word is incorrect the matching algorithm will return a no-match. In that case, one way to re-test would be to delete the last word and process with only the first two instead.

Once a match or equivalent match is found, the corresponding result will be displayed indicating chapter/verse information together with additional information that is highlighted to the user for his attention.

### Abstract of the Disclosure:

The invention allows people to check the correctness of the printed verses against the authentic version of the Holy Quran. It also provides the ability to check Holy Quran's verses written in the scientific papers and in web pages. Using this mechanism we will help in protecting the Holy Quran from any distortion. This project is important because of the following:

1. The Internet became very wide and many sites are citing Quran verses. Sometimes the used verses contain some intentional or unintentional mistakes. Many of the Internet users do not notice these mistakes.
2. The increasing number of Muslims as well as the people who are joining Islam, taking into consideration that many of them does not speak Arabic.
3. The need to print and distribute many copies of Quran all over the world after revising and correcting them. This task requires time, effort and expert people in the Holy Quran.

This invented mechanism has many advantages, some of which are listed below:

1. Easy to use and does not require from the user to be an expert in the Holy Quran.
2. Saving the time that is required to revise the Holy Quran.
3. This mechanism can be utilized at Islamic centers in the non-Muslim countries to make sure that Muslim people there have correct copies of the Holy Quran.

What is claimed is:

1. A mechanism that enables effectively checking the integrity of the Holy Quran script. The mechanism checks the integrity of the script by utilizing hash tables. The claimed mechanism comprises:
construction of the First Hash Table, which maps words to the hash codes of verses containing them;
construction of the Data Table, which stores the actual content of the verses; and
construction of the Linking Table, which links First Table with the Data Table via the hash codes of the verses.

2. An embodiment of the mechanism in claim 1 where the mechanism is embedded in a website. The website in which the mechanism is embedded comprises the following:
ability to check the integrity of Quran verses embedded in a third-party website that the user provides; and
ability to check the integrity of verses which the user explicitly and directly inputs.

3. An embodiment of the mechanism in claim 1 where the mechanism is embedded or used in conjunction with an automated scanner. This setup would allow for the fully automated integrity checking of printed Holy Quran books in their final form. This setup is comprised of the following:
the use of a scanner that has an automated page turning capability;
the use of the mechanism mentioned in claim 1 to automatically check the integrity of the scanned page;
the triggering of the page turner once the page is scanned and checked; and
the classification of the books as valid or invalid based on the results of the validation of individual scanned pages.
